(19) United States
(12) Patent Application Publication
(10) Pub. No.: US 2026/0362286 A1
(43) Pub. Date: Nov. 12, 2026

(54) A COMPUTER IMPLEMENTED METHOD FOR SECURE TRANSMISSION OF A DATA MESSAGE FROM A SOURCE NODE TO A TARGET NODE

(71) Applicant: SAAB AB, Linköping (SE)

(72) Inventors: Alexander WESTERHAGEN, Karlskrona (SE); Dragos ILIE, Rödeby (SE); Lars LUNDBERG, Karlshamn (SE); Håkan GRAHN, Karlskrona (SE); Bo GRANBOM, Linköping (SE)

(21) Appl. No.: 19/131,799

(22) PCT Filed: Nov. 24, 2023
(86) PCT No.: PCT/SE2023/051189

§ 371 Date: May 21, 2025

(30) Foreign Application Priority Data
Nov. 24, 2022 (SE) 2200136-6

(51) Int. Cl. H04W 40/20; H04W 12/102; H04W 84/18

(52) U.S. Cl. CPC H04W 40/20; H04W 12/102; H04W 84/18

(57) ABSTRACT

The present invention relates to a computer implemented method (100), performed in a first communication node, for secure transmission of a data message from a source node (302a) to a target node (302f) through one or more intermediate nodes (302b-e), The method (100) comprising: obtaining (S104) situational awareness (SA) data of one or more potential communication nodes, wherein the situational awareness data comprises information about a position and movement of said one or more potential communication nodes, and a classification defining each of said one or more potential communication nodes as either friendly or unfriendly; determining (S114) a routing table of the one or more potential communication nodes, wherein the routing table comprises routing costs of a plurality of transmission paths (P_1-P_10) between a set of communication node-pairs of the one or more potential communication nodes, and wherein the routing costs are based on the situational awareness data; determining (S116) a routing path

### TECHNICAL FIELD

The present invention relates to the field of wireless communication networks. In particular, the present invention relates to a computer implemented method for secure transmission of a data message from a source node to a target node in a wireless communication network comprising a plurality of nodes.

### BACKGROUND OF THE INVENTION

Today's communication solutions between nodes in wireless communication networks are commonly based on omni-directional communication (broadcast architecture), i.e. utilizing omnidirectional antennas. A general drawback of such solutions is that they are exposed to security risks since there is no control of who or what might intercept the communication. Another drawback of such solutions is that it is possible for a third party to determine (e.g. by triangulation) the position of the transmitter. Yet another drawback of such solutions is that they are energy inefficient as power is radiated in directions where there are no receivers. Another drawback of these types of “broadcast architectures” is that it is virtually impossible or at least very difficult to continuously stream data as these solutions rely on a determination of time slots during which each node is allowed to transmit. Therefore these solutions require time/frequency scheduling, which oftentimes results in slow and inefficient communication between the nodes.

To this end, directional communication solutions may be utilized to alleviate some of the disadvantages of omni-directional communication. However, other issues related to cost, complexity and reliability arise for the directional communication solutions that are known today.

More specifically, it is desirable to be able to send/receive signals in all directions, however, this may require a large number of antennas in order to provide the same coverage as omni-directional communication solutions, which adds to the cost and weight of the platform. However, electronically steerable arrays may be used to reduce the number of antennas, but there are still issues associated with keeping track of where the other nodes are located in order to be able to determine where the signal is supposed to be sent (or from which direction a signal is supposed to be received) in addition to the determination of how much power needs to be supplied to the antenna. Further, it may require additional, or more advanced, signal processing. These aspects are also closely related to the security aspect of the transmission between nodes, as mentioned above, which still remains as a problem. Thus, there is need for improved solutions in mobile and wireless communication networks.

### SUMMARY OF THE INVENTION

The herein disclosed technology seeks to at least partly mitigate, alleviate or eliminate one or more of the above-mentioned deficiencies and disadvantages in the prior art. In particular to address various problems relating to communication between wireless communication nodes.

The inventors have realized that by utilizing situational awareness data, a communication protocol which facilitates a more secure and effective communication can be achieved. More specifically, each communication node can utilize its own (and/or a shared) situational awareness to determine a most suitable path to relay a data message towards an indented recipient through one or more intermediate nodes.

Various aspects and embodiments of the disclosed invention are defined below and in the accompanying independent and dependent claims.

According to a first aspect, a method, performed in a first communication node, for secure transmission of a data message from a source node to a target node through one or more intermediate nodes is provided. The method comprises obtaining situational awareness, SA, data of one or more potential communication nodes, wherein the situational awareness data comprises information about a position and movement of said one or more potential communication nodes, and a classification defining each of said one or more potential communication nodes as either friendly or unfriendly. The method further comprises determining a routing table of the one or more potential communication nodes, wherein the routing table comprises routing costs of a plurality of transmission paths, between a set of communication node-pairs of the one or more potential communication nodes, and wherein the routing costs are based on the situational awareness data. The method further comprises determining a routing path from the first communication node to the target node via one or more selected communication nodes of the one or more potential communication nodes, based on the routing table. The method further comprises transmitting, in accordance with the determined routing path, the data message to a second communication node of the one or more selected communication nodes, wherein the data message comprises information identifying the target node.

The proposed method provides for a dynamic routing protocol where each communication node is able to decide to which node it should transmit the data message next, based on its current perception of the surrounding environment. Not only can the communication node find the most secure routing path based on its available SA data, but it also allows each communication node to make its own evaluation if the situation were to change during the routing of the data message from the source node to the target node. In other words, the proposed method allows for a routing protocol which can take into account any changes in the situation (and adapt the routing path if needed) while still having the target recipient in mind.

The first communication node may be the source node. Thus, the first node may be the origin of the data message. In other cases (e.g. if the first node is an intermediate communication node between the source and target node, the method may further comprise receiving the data message from a third communication node. The third communication node may in such case be the source node, or any intermediate node between the source node and the first communication node.

The second communication node may be the target node. In other words, the second communication node may be the node which the data message is intended for. Alternatively, the second communication node may be an intermediate node.

The method may further comprise determining one or more unsecure transmission directions and/or one or more unsecure sectors for the one or more potential communication nodes based on the obtained SA data. Determining the routing table may be further based on the one or more unsecure transmission directions and/or the one or more unsecure sectors.

An unsecure transmission direction may be a direction from the first communication node in which there is a risk of the data message being intercepted or in which there is a risk of the position of the first communication node can be determined, e.g. by an unfriendly node. Similarly, an unsecure sector may be a sector where there is a risk of the data message being intercepted or in which there is a risk of the position of the first communication node being determined, e.g. by an unfriendly node.

The method may further comprise determining one or more disrupted transmission directions and/or one or more disrupted sectors for the one or more potential communication nodes based on the obtained SA data. Determining the routing table may be further based on the one or more disrupted transmission directions and/or the one or more disrupted sectors.

A disrupted transmission direction may be a direction from the first communication node in which there is a risk of the data message not being properly delivered to an intended node, e.g. as a result of an antenna malfunction or interference by e.g. an unfriendly node. Similarly, a disrupted sector may be a sector where there is a risk of the data message not being properly delivered by an intended communication node as a result of an antenna malfunction or interference by e.g. an unfriendly node. The interference may for instance be done by jamming of radio signals.

The data message may be associated with a priority score. Determining the routing path may be further based on the priority score of the data message.

Taking the priority score into account when determining the routing path may be advantageous in that it allows for a further improved routing of the data message since properties of the data message itself can be taken into account. For example, the priority score may relate to a classification level of the data message. Thus, a routing path where security is prioritized over length of path can be selected. In another example, the priority score may relate to an importance of the data message reaching the target node as fast as possible. In such case, the shortest possible path may be selected, where the security may be of less importance.

Determining the routing path may further comprise selecting the routing path having the lowest total routing cost. Put differently, determining the routing path “based on the routing table” may be interpreted as selecting the routing path having the lowest total routing cost. By the wording “total routing cost” it is herein meant an aggregation of the routing cost of the individual transmission paths which constitute the routing path.

Determining the routing path may further comprise selecting the routing path as a routing path where no individual transmission path of the routing path has a routing cost exceeding a threshold. Put differently, the routing path may be selected such that the transmission path of the routing path having the highest routing cost does not exceed the threshold.

Obtaining the situational awareness data may comprise: obtaining positional information about an available friendly communication node, based on a situational awareness of the first communication node; transmitting, to the available communication node, a first message comprising an indication of that the situational awareness data of the one or more potential communication nodes is sought; and receiving the situational awareness data of the one or more potential communication nodes, from the available communication node.

A possible associated advantage may be that it facilitates a simplified acquisition of SA data of the potential communication nodes. By only having to communicate with one other node, as opposed to having to communicating with each of the potential communication nodes, the security risk is further reduced.

Transmitting the data message to the second communication node may be performed by directional antennas. Using directional antennas may be advantageous in that it can reduce the risk of the data message being intercepted. Put differently, the data message may be transmitted S124 using an electrically steerable antenna. This may be done e.g. for the purpose of reducing the risk of the data message being intercepted, reducing the risk of the data message being interfered with, or reducing the risk of the position of the transmitting communication node being acquired by unfriendly nodes.

The method may further comprise setting transmission parameters of the first communication node based on the situational awareness data. Setting the transmission parameters based on the SA data can further improve the security of the data transmission. For example, the data message may be transmitted based on the position and movement of the second communication node, and any unfriendly nodes, such that the risk of eavesdropping of the data transmission is reduced.

The situational awareness data may be maintained by a wireless communication network formed by a plurality of friendly communication nodes. Put differently, the SA data may be stored and updated by the wireless communication network. This way, a new communication node wanting to connect to the wireless communication network can obtain the SA data from any available communication node of the wireless communication network.

The method may further comprise, at a time interval, transmitting updated situational awareness data of the first communication node itself to at least one other communication node of the wireless communication network and/or receiving updated situational awareness data associated with at least one other communication node of the wireless communication network. By continuously updating the SA data provides for a more accurate view of the surrounding environment, and thus for a more secure transmission of the data message. The updated situational awareness data may be transmitted to all communication nodes within an communication range of the first communication node.

The wireless communication network may be a mobile ad-hoc network, MANET. The wireless communication network may be a flying ad-hoc network, FANET.

The wireless communication network may be any one of an air-to-air, air-to-surface, or surface-to-surface communication network.

The communication nodes may be aircraft. The communication nodes may be surface vessels, land vehicles and/or fixed infrastructure.

According to a second aspect of the present inventive concept, there is provided a computer program product comprising instructions which, when the program is executed by a one or more processors of a computing device, causes the computing device to carry out the method according to any one of the embodiments disclosed herein. The above-mentioned features of the first aspect, when applicable, apply to this second aspect as well. In order to avoid undue repetition, reference is made to the above.

According to a third aspect of the present inventive concept, a (non-transitory) computer-readable storage medium is provided. The non-transitory computer-readable storage medium stores one or more programs configured to be executed by one or more processors of a processing system, the one or more programs comprising instructions for performing the method according to any one of the embodiments disclosed herein. The above-mentioned features of the first and second aspects, when applicable, apply to this third aspect as well. In order to avoid undue repetition, reference is made to the above. The term “non-transitory,” as used herein, is intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link. Thus, the term “non-transitory”, as used herein, is a limitation of the medium itself (i.e., tangible, not a signal) as opposed to a limitation on data storage persistency (e.g., RAM vs. ROM).

According to a fourth aspect of the present inventive concept, a communication node configured to transmit and receive data messages in a network of communication nodes is provided. The communication node comprising: a sensor module configured to determine situational awareness data of the communication node, wherein the situational awareness data comprises information about a position and movement of neighboring communication nodes and a classification defining each neighboring node as either friendly or unfriendly; and a communication module configured to transmit and receive data messages from and to the communication node, wherein the communication module comprises circuitry configured to: obtain situational awareness data of one or more potential communication nodes, determine a routing table of the one or more potential communication nodes, wherein the routing table comprises routing costs of a plurality of transmission paths between a set of communication node-pairs of the one or more potential communication nodes, and wherein the routing costs are based on the situational awareness data, determine a routing path from the communication node to a target node via one or more selected communication nodes of the one or more potential communication nodes, based on the routing table, and transmit, in accordance with the determined routing path, a data message to a second communication node of the one or more selected communication nodes, wherein the data message comprises information identifying the target node. The above-mentioned features of the first, second and third aspects, when applicable, apply to this fourth aspect as well. In order to avoid undue repetition, reference is made to the above.

A further scope of applicability of the present disclosure will become apparent from the detailed description given below. However, it should be understood that the detailed description and specific examples, while indicating preferred variants of the present inventive concept, are given by way of illustration only, since various changes and modifications within the scope of the inventive concept will become apparent to those skilled in the art from this detailed description.

Hence, it is to be understood that this inventive concept is not limited to the particular steps of the methods described or component parts of the systems described as such method and system may vary. It is also to be understood that the terminology used herein is for purpose of describing particular embodiments only and is not intended to be limiting. It must be noted that, as used in the specification and the appended claim, the articles “a”, “an”, “the”, and “said” are intended to mean that there are one or more of the elements unless the context clearly dictates otherwise. Thus, for example, reference to “a device” or “the device” may include several devices, and the like. Furthermore, the words “comprising”, “including”, “containing” and similar wordings do not exclude other elements or steps.

### BRIEF DESCRIPTION OF THE DRAWINGS

The above and other aspects of the present inventive concept will now be described in more detail, with reference to appended drawings showing variants of the present inventive concept. The figures should not be considered limiting the invention to the specific variant; instead, they are used for explaining and understanding the inventive concept.

As illustrated in the figures, the sizes of layers and regions are exaggerated for illustrative purposes and, thus, are provided to illustrate the general structures of variants of the present inventive concept. Like reference numerals refer to like elements throughout.

FIG. 1A is a flow chart illustrating the steps of a computer-implemented method for secure transmission of a data message from a source node to a target node through one or more intermediate nodes according a preferred embodiment.

FIG. 1B is a flow chart illustrating the steps of a computer-implemented method for secure transmission of a data message from a source node to a target node through one or more intermediate nodes according a number of alternative embodiments.

FIG. 2 is a schematic illustration of a communication node.

FIG. 3A to 3C schematically illustrates, by way of example, how a data message may be securely transmitted in a wireless communication network.

### DETAILED DESCRIPTION

The present inventive concept will now be described more fully hereinafter with reference to the accompanying drawings, in which currently preferred variants of the inventive concept are shown. This inventive concept may, however, be implemented in many different forms and should not be construed as limited to the variants set forth herein; rather, these variants are provided for thoroughness and completeness, and fully convey the scope of the present inventive concept to the skilled person.

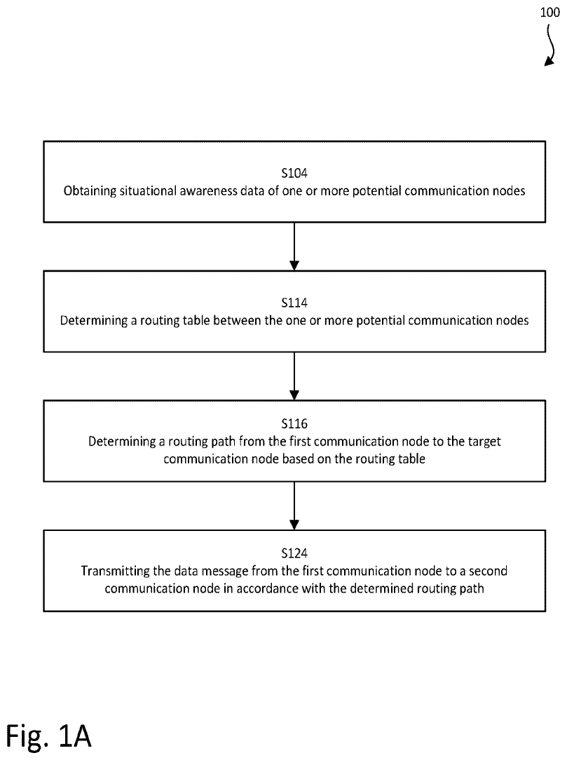

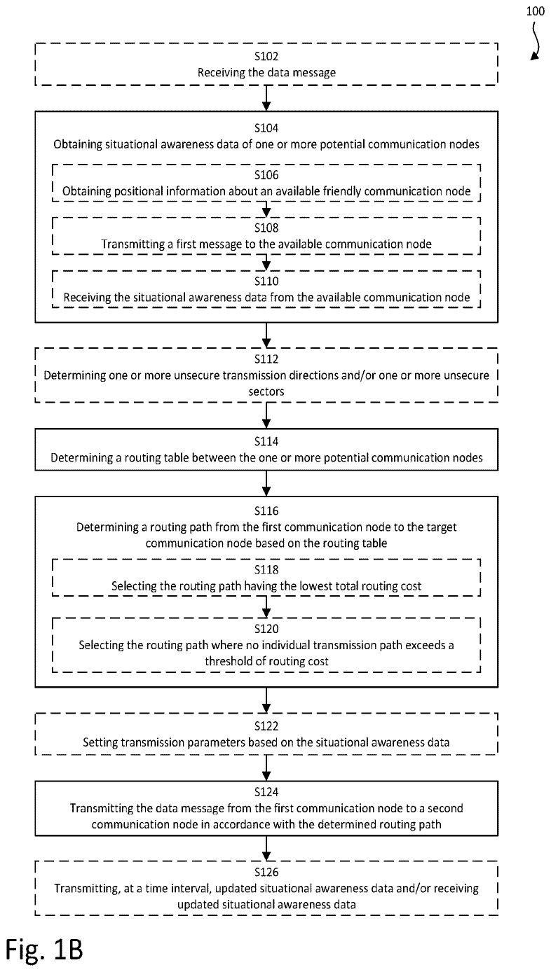

A computer implemented method for secure transmission of a data message from a source node to a target node through one or more intermediate nodes, as well as a communication node thereof will now be described with reference to FIG. 1 to FIG. 3C.

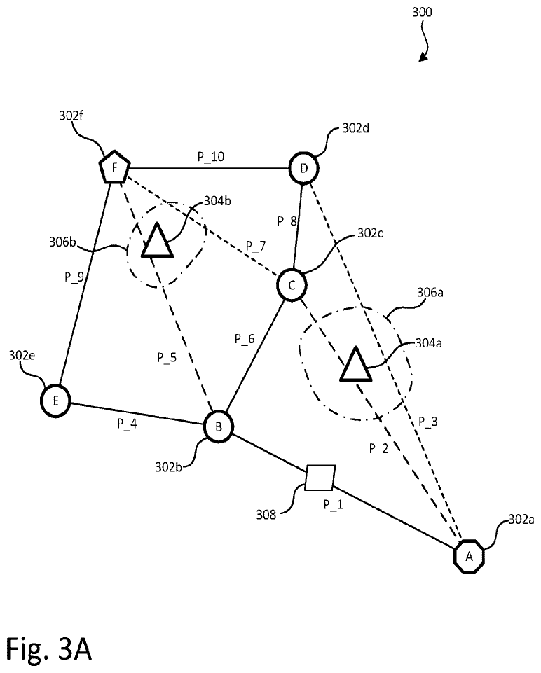

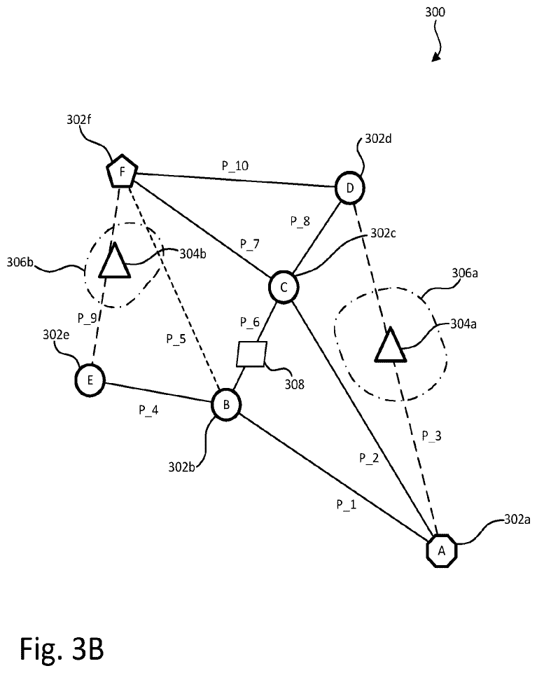

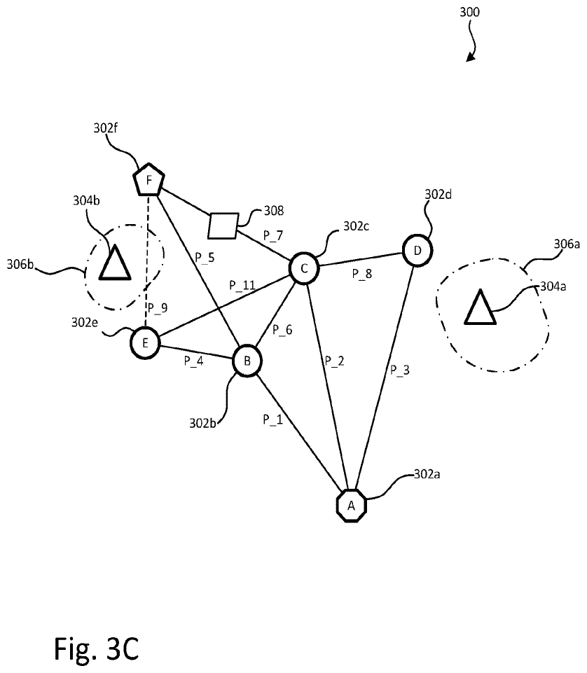

In short, the presently disclosed technology relates to a communication protocol with improved security, realized as a method performed in a communication node, as well as a communication node thereof. It is at least partly based upon utilizing situational awareness data of both friendly and unfriendly nodes to determine a suitable path to relay a message towards an intended recipient via nodes in the network (also referred to as wireless communication network below). The friendly nodes may be understood as nodes belonging to the network. Thus, the friendly nodes can be used to relay the message through. The unfriendly nodes may be understood as nodes that are not part of the network, through which the message should not be transmitted. They are however referred to herein as “potential” communication nodes as they could potentially intercept a transmitted message. A routing path between a communication node and the target node can be determined based on a routing table. The routing table, in turn, comprises routing costs of a plurality of transmission paths between a set of communication node-pairs. The set of communication node-pairs may be pairs of friendly communication nodes. The routing cost may then be based on the situational awareness data of the communication nodes being classified as either friendly or unfriendly. This may provide for increased security in the selection of the routing path. For example, in a situation where an unfriendly node is in a vicinity of (or travelling in the direction of) a friendly node (or between two friendly nodes), the determined routing cost can reflect this as being a less secure transmission path, as there may be an increased risk of the data message being intercepted by the unfriendly node. This is further exemplified in connection with FIG. 3A to 3C below.

Rather than dealing with security risk “inside” the network, i.e. to determine whether a node in the network can be trusted or not, the presently disclosed technology can be seen as dealing with security risk “outside” the network, by taking into account also situational awareness data of out-of-network nodes (i.e. unfriendly nodes not part of the network, which may try to intercept the transmitted messages) when selecting the routing path. In other words, the routing cost between two (“friendly”) nodes can be determined to also take into account the position and movement of a third (“unfriendly”) node. In the following, the presently disclosed technology will be described in more detail.

FIG. 1A is a flow chart illustrating the steps of a preferred embodiment of the method 100 for secure transmission of a data message from a source node to a target node through one or more intermediate nodes. FIG. 1B is another flow chart which in addition to the steps illustrated in FIG. 1A, also shows a number of optional steps of the method 100 forming a number of alternative embodiments of the method 100.

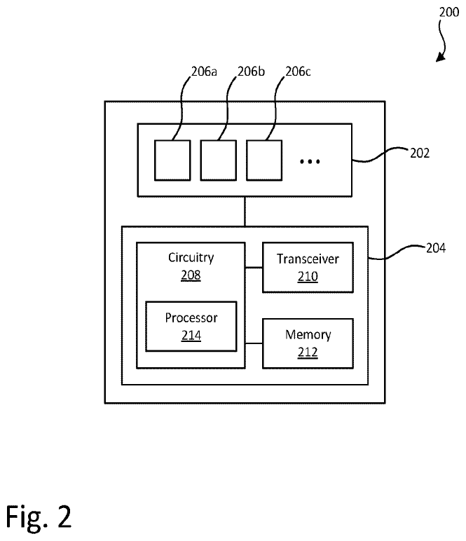

The method 100 describes what steps are performed in one communication node (herein denoted as a first communication node). In other words, the method 100 may be performed in, or by, the first communication node. The first communication node may be a communication node as described below in connection with FIG. 2. The communication node may be a stationary node. Alternatively, the communication node may be a mobile node. The communication node may be a sea, land or air based vehicle. The communication node may be either a manned or unmanned vehicle. Preferably, the communication node may be an aircraft, such as an airplane, a helicopter, a drone etc. Alternatively, the communication node may be a surface vessel (e.g. marine or seaborne vessels), a land vehicle, or fixed infrastructure.

It should be noted that any number of routing instances may be required to transmit the data message from the source node to the target node. Put differently, the method 100 may be repeated for any number of times (by any number of communication nodes) until the data message reaches the intended target node.

The wording “data message” should be interpreted broadly as any type of data or information which could be transmitted between nodes in a wireless communication network.

In the following, the different steps are described in more detail with reference to both FIGS. 1A and 1B. Even though illustrated in a specific order, the steps of the method 100 may be performed in any suitable order, in parallel, as well as multiple times.

Situational awareness data (in the following referred to as SA data) of one or more potential communication nodes is obtained S104. By the wording “potential” as in “potential communication nodes” it is herein meant any communication nodes which could transmit and/or receive the data message sent by the first communication node. Thus, the potential communication nodes could potentially be used to relay the data message from the first communication node one step closer to the target node. However, the potential communication nodes may also comprise unfriendly nodes, which could eavesdrop on the transmitted data message. The unfriendly potential communication nodes may be seen as “potential” in the sense that they (at least) may intercept (i.e. receive) the data message. The potential communication nodes of which SA data is obtained may be all possible communication nodes which are present in a vicinity of the first communication node.

The SA data comprises information about a position and movement of the one or more potential communication nodes (also referred to as the potential communication nodes). The information about position may be GPS coordinates of the potential communication nodes. Alternatively, or in combination, the position may be relative positions of the potential communication nodes to the first communication node. The information about the movement of the potential communication nodes may comprise any physical parameters of how the potential communication nodes are moving, such as velocity, acceleration, jerk, heading direction etc. The SA data may comprise information about the current position and movement of the potential communication nodes. However, the SA data may further comprise information about previous position and movement of the potential communication nodes, as well as predicted future position and movement. The SA data may further comprise information about a position and movement of the first communication node itself.

The SA data further comprises a classification defining each of the one or more potential communication nodes as either friendly or unfriendly. The classification should be interpreted as any type of information identifying the communication nodes as friendly or unfriendly. A potential communication node being either friendly or unfriendly may be seen as whether the potential communication node can be trusted or not. Put differently, a friendly communication node may be a communication node which can be used in relaying the data message from the source node to the target node. Thus, the friendly communication mode may be seen as a communication node being part of a wireless communication network (as further described below). In contrast, an unfriendly communication node may be a communication node which cannot be used in relaying the data massage from the source node to the target node. In other words, the unfriendly communication nodes may be seen as nodes outside of the wireless communication network. An unfriendly communication node may even be a communication node which is to be prevented from intercepting the data message. Thus, in order to achieve the secure transmission of the data message from the source node to the target node, any unfriendly communication node should be avoided. In conclusion, the SA data may comprise information about the position and movement of both friendly nodes (i.e. possible intermediate nodes for relaying the data message) and unfriendly nodes (i.e. anything that could compromise the security of the data transmission).

The SA data may be individual SA data of the first communication node. In other words, the SA data may comprise information about how the first communication node perceives its own surrounding environment (e.g. position and movement of other communication nodes in a vicinity of the first communication node, and/or the terrain). In such case, the SA data may be determined by the first communication node. The SA data may for example be determined by perception technologies of the first communication node, such as sensors, RADAR, map data, and/or information about its own position and movement. The SA data is in this case limited to what the first communication node can perceive from its own surrounding environment. Even still, a possible associated advantage may be that the first communication node need not to interact with the other communication nodes (i.e. the one or more potential communication nodes), but can form its own belief of the surrounding environment irrespectively of the other nodes. This may especially be advantageous in case the target node is within a perception range of the first communication node.

Alternatively, or in combination, the SA data may be fused SA data of one or more communication nodes. The fused SA data may be formed by the SA data of the node itself (i.e. the first communication node) and SA data of one or more friendly communication nodes. In other words, the SA data may comprise information about how the different communication nodes perceives their respective surrounding environment. Hence, the SA data may comprise SA data from several communication nodes. The SA data of the different communication nodes may be combined to form the fused SA data. The fused SA data provides for a shared view of the surrounding environment. This may be advantageous in that it can give an extended view of the surrounding environment, since different communication nodes may have different field of views. It may further provide a more accurate picture of the surrounding environment since SA data of several communication nodes is taken into account. Thus, the routing path can be determined in a more secure and more efficient way. The routing can be made more efficient e.g. in terms of speed/time it takes for the data message to reach the target node, reduced energy requirements, or reduced data congestion.

Obtaining S104 the SA data may comprise obtaining S106 positional information about an available friendly communication node, based on a situational awareness of the first communication node. The positional information herein refers to information required to allow the first communication node to transmit a message to the available communication node. For example, the positional information may include a geographical position of the available node or a position of the available node relative the first communication node.

The positional information may further comprise information about movement of the available node (e.g. velocity, acceleration, jerk and heading direction). By the wording “available”, it is herein meant that the communication node is within communication range of the first communication node. Preferably, a secure transmission path between the available communication node and the first communication node is present. Obtaining S104 the SA data may further comprise transmitting S108, to the available communication node, a first message comprising an indication of that the situational awareness data of the one or more potential communication nodes is sought. The first message may further comprise an identification of the first communication node and/or an authorization of the first communication node to obtain the SA data. The first message may then be used by the available communication node to verify that the first communication node is allowed to receive the SA data. Obtaining S104 the SA data may further comprise receiving S110 the situational awareness data of the one or more potential communication nodes, from the available communication node. In response to receiving the SA data of the one or more potential communication nodes, the first communication node may transmit its own SA data to the available communication node. The available communication node may thus be used as a single point of access for obtaining the SA data of the one or more potential communication nodes. This may be advantageous in that the first communication node can access the SA data even if only one potential communication node is available.

Moving on, a routing table of the one or more potential communication nodes is determined S114. The routing table may comprise information about possible transmission paths between the first communication node and the potential communication nodes. The routing table comprises routing costs of a plurality of transmission paths (P_1-P_10) between a set of communication node-pairs of the one or more potential communication nodes. More specifically, the routing table may be a routing table of the one or more potential nodes being classified as friendly. In other words, the routing table may comprise routing costs of a plurality of transmission paths (P_1-P_10) between a set of communication node-pairs of the one or more potential communication nodes being classified as friendly. The routing cost may then be based on the situational awareness data of the potential communication nodes being classified as either friendly or unfriendly. In other words, the routing table may comprise routing costs of transmission paths between the friendly nodes (e.g. the nodes being part of the network), while the routing costs are based on SA data of both the friendly nodes and the unfriendly nodes. Thus, the method may comprise determining S114 a routing table of the one or more potential communication nodes being classified as friendly, wherein the routing table comprises routing costs of a plurality of transmission paths, between a set of communication node-pairs of the one or more potential communication nodes being classified as friendly, and wherein the routing costs are based on the situational awareness data of the potential communication nodes being classified as friendly or unfriendly.

By the wording “transmission path” it is herein meant a direct path between two communication nodes (i.e. a communication node-pair). Thus, the routing table comprises a plurality of possible transmission paths, and each transmission path is associated with a routing cost. The routing table may take into account the so called k-shortest path routing algorithm. The routing cost may be seen as a measure of how secure the transmission path is. The routing costs are based on the situational awareness data. More specifically, a relatively high routing cost may be assigned to a transmission path which based on the SA data can be regarded as relatively unsecure. As an example, a high routing cost may be assigned to the transmission path if it passes through, or close to, an unfriendly communication node. A transmission path which instead can be regarded as relatively secure, can be assigned a relatively low routing cost. Thus, the lower the routing cost is, the more secure the transmission path may be. It should however be noted that the routing cost may also take into account how the friendly communication nodes are positioned in relation to each other. For example, a longer transmission path between two nodes may lead to a higher routing cost than of a shorter transmission path.

As stated above, the routing table comprises a plurality of transmission paths between a set of communication node-pairs. The set of communication node-pairs may comprise any number of combinations of communication-node pairs. For example, the routing table may comprise transmission paths and their corresponding routing cost for a number of neighboring communication nodes. Alternatively, the set of communication node-pairs may comprise all possible combinations of pairs between the potential communication nodes. The set of communication node-pairs comprise the potential communication nodes which are classified as friendly. In other words, the routing table comprises transmission paths between the friendly communication nodes. The transmission paths are further described in connection with FIG. 3A to 3C.

Moving on, a routing path from the first communication node to the target node via one or more selected communication nodes of the one or more potential communication nodes, is determined S116, based on the routing table. Put differently, the routing path may be formed by a plurality of transmission paths selected from the routing table. The selected communication nodes herein refers to the communication nodes which are connected through the selected transmission paths. The selected communication nodes may also be referred to as intermediate nodes. More specifically, the routing path may be determined based on the routing costs of the transmission paths of the routing table. This may be done in several different ways as described below. The routing path from the first communication node to the target node 302f may be determined S116 via one or more selected communication nodes of the one or more potential communication nodes being classified as friendly, based on the routing table. In other words, the routing path may be determined as a path between the potential communication nodes being classified as friendly. Thus, the method 100 may comprise determining S116 a routing path from the first communication node to the target node via one or more selected communication nodes of the one or more potential communication nodes being classified as friendly, based on the routing table.

Determining S116 the routing path may comprise selecting S118 the routing path having the lowest total routing cost. In other words, the routing path may be determined by selecting the transmission paths having the lowest aggregated routing cost.

Determining S116 the routing path may comprise selecting S120 the routing path as a routing path where no individual transmission path of the routing path has a routing cost exceeding a threshold. In other words, the routing path may be determined by selecting only transmission paths which has a routing cost below the threshold.

It should be noted that the routing path may be determined S116 by selecting the transmission paths which both gives the lowest total routing cost, and where each individual transmission path has a routing cost below the threshold.

The data message may be associated with a priority score. Determining S116 the routing path may be further based on the priority score of the data message. The priority score may define how important it is that the data message reaches the target node. Alternatively, the priority score may define how important it is that the data message is transmitted to the target node securely. This may for example be achieved by setting the threshold of the routing cost based on the priority score. For instance, if the priority score indicates that high security is important, a low threshold of the routing cost may be used.

Moving on, the data message is transmitted S124, in accordance with the determined routing path, to a second communication node of the one or more selected communication nodes. The data message comprises information identifying the target node. The second communication node herein refers to the selected communication node which is reached by transmitting the data message through an transmission path of the routing path originating from the first communication node. In other words, the first communication node performs the first transmission step of the determined routing path. Thus, the second communication node may be the next node in line.

Transmitting S124 the data message to the second communication node may be performed by directional antennas. Put differently, the data message may be transmitted by a directed signal. By using directional antennas, the risk of the data message being intercepted and or detected, e.g. by an unfriendly node, can be reduced.

The method may further comprise setting S122 transmission parameters of the first communication node based on the situational awareness data. The transmission parameters may for example relate to a transmission power and/or a transmission (beam) pattern of the first communication node. This may for instance be used to perform (beam) pattern shaping or nulling of directions, as well as adaptive transmit power control. This may be utilized to further improve the security of the transmission.

The data identifying the target node allows the second communication node to know which node is the target node. Upon the second communication node receiving the data message and the data identifying the target node, the method 100 may be repeated in the second communication node. This may then be repeated until the data message reaches the target node.

The first communication node as described herein may be the source node. Alternatively, the first communication node may be an intermediate node between the source node and the target node. In the case where the first communication node is an intermediate node, the method 100 may further comprise receiving S102 the data message from a third communication node. The third communication node may in turn be the source node or an intermediate communication node previous to the first communication node. Hence, the first communication node may in such case be configured to receive the data message from the third communication node and transmit it to the second communication node. The second communication node may be the target node. Alternatively, the second communication node may be another intermediate node. In other words, three different cases may be distinguished. In a first case, the first communication node may be the source node while the second communication node is an intermediate node. In a second case, the first communication node may be an intermediate node while the second communication node is another (subsequent) intermediate node. In a third case, the first communication node may be an intermediate node while the second communication node is the target node. In the second and third case, the method 100 may further comprise receiving S102 the data message from the third communication node.

Optionally, one or more unsecure transmission directions and/or one or more unsecure sectors may be determined S112 for the one or more potential communication nodes, based on the obtained SA data. Determining S114 the routing table may be further based on the one or more unsecure transmission directions and/or the one or more unsecure sectors. A direction may for example be unsecure if there is risk for unfriendly communication nodes being present, or if there is any other risk of the data message being intercepted. Similarly, an unsecure sector may define an area where there is risk for the data message being intercepted.

A plurality of friendly communication nodes (e.g. the first communication node and one or more of the potential communication nodes classified as friendly) may form a wireless communication network. The wireless communication network may be any one of an air-to-air (A2A) communication network, an air-to-surface (A2S) communication network or surface-to-surface (S2S) communication network. The wireless communication network may for example be a mobile ad-hoc network (MANET).

The situational awareness data may be maintained by the wireless communication network formed by the plurality of friendly communication nodes. For instance, the SA data of the communication nodes of the wireless communication network may be continuously updated and available to the communication nodes of the wireless communication network. In particularly, the method 100 may further comprise, at a time interval, transmitting S126 updated situational awareness data of the first communication node itself to at least one other communication node of the wireless communication network and/or receiving updated situational awareness data associated with at least one other communication node of the wireless communication network.

FIG. 2 is a schematic illustration of a communication node 200 of the present inventive concept. The communication node 200 is configured to transmit and receive data messages in a network of communication nodes (e.g. the wireless communication network as described herein, in connection with FIG. 1A, 1B and 3A to 3C). In particular, the communication node 200 is configured to perform the method 100 as described above in connection with FIGS. 1A and 1B. Any aspects or advantages described above in connection with the method 100 applies to the communication node 200 as described below, and vice versa.

The communication node 200 comprises a sensor module 202. The sensor module 202 may comprise one or more sensors 206a-c to perceive the surroundings of the communication node. As an example, the one or more sensors 206a-c may be radar, LIDAR, sonar, camera, navigation system e.g. GPS, odometer and/or inertial measurement units (IMUs). The sensor module is configured to determine situational awareness (SA) data of the communication node 200. The SA data comprises information about a position and movement of neighboring communication nodes, i.e. communication within range of the sensor module 202. The SA data further comprises a classification defining each neighboring node as either friendly or unfriendly. The classification of the neighboring nodes may be determined passively (i.e. by the communication node 200 itself) through e.g. visual confirmation. Alternatively, or in combination, the classification of the neighboring nodes may be determined interactively, e.g. by requesting an authentication by the neighboring node. The sensor module may further be configured to determine information regarding the position and movement (e.g. velocity, acceleration, jerk and heading direction) of the communication node 200 itself. In summary, the sensor module 202 may be configured to determine how the communication module 200 itself perceives its surrounding environment.

The communication node 200 further comprises a communication module 204. The communication module is configured to transmit data messages from the communication node 200 (e.g. to other communication nodes of a wireless communication network). The communication module 204 is further configured to receive data messages to the communication node 200 (e.g. from other communication nodes of a wireless communication network).

The communication module 204 comprises circuitry 208. The circuitry 208 may physically comprise one single circuitry device. Alternatively, the circuitry 208 may be distributed over several circuitry devices. As shown in the example of FIG. 2, the communication module 204 may further comprise a transceiver 210 and a memory 212. The circuitry 208 being communicatively connected to the transceiver 210 and the memory 212. The circuitry 208 may comprise a data bus (not illustrated in FIG. 2), and the circuitry 208 may communicate with the transceiver 210 and/or the memory 212 via the data bus.

The circuitry 208 may be configured to carry out overall control of functions and operations of the communication module 204. The circuitry 208 may include a processor 214, such as a central processing unit (CPU), microcontroller, or microprocessor. The processor 214 may be configured to execute program code stored in the memory 212, in order to carry out functions and operations of the communication module 204.

The transceiver 210 may be configured to enable the communication module 204 to communicate with other communication nodes. The transceiver 210 may both transmit data from and receive data to the communication module 204 (and thus also the communication node 200). The transceiver 210 may transmit and receive data via radio communication protocols, e.g. by using radio antennas. Preferably, the transceiver 210 may use directional antennas of the communication node 200, to communicate with other communication nodes through direct signals.

The memory 212 may be a non-transitory computer-readable storage medium. The memory 212 may be one or more of a buffer, a flash memory, a hard drive, a removable media, a volatile memory, a non-volatile memory, a random access memory (RAM), or another suitable device. In a typical arrangement, the memory 212 may include a non-volatile memory for long term data storage and a volatile memory that functions as system memory for the communication module 204. The memory 212 may exchange data with the circuitry 208 over the data bus. Accompanying control lines and an address bus between the memory 212 and the circuitry 208 also may be present.

Functions and operations of the communication module 204 may be implemented in the form of executable logic routines (e.g., lines of code, software programs, etc.) that are stored on a non-transitory computer readable recording medium (e.g., the memory 212) of the communication module 204 and are executed by the circuitry 208 (e.g. using the processor 214). Put differently, when it is stated that the circuitry 208 is configured to perform a specific operation, or execute a specific function, the processor 214 of the circuitry 208 may be configured execute program code portions stored on the memory 212, wherein the stored program code portions correspond to the specific operation or function. Furthermore, the functions and operations of the circuitry 208 may be a stand-alone software application or form a part of a software application that carries out additional tasks related to the circuitry 208. The described functions and operations may be considered a method that the corresponding device is configured to carry out, such as the method discussed above in connection with FIGS. 1A and 1B. Also, while the described functions and operations may be implemented in software, such functionality may as well be carried out via dedicated hardware or firmware, or some combination of one or more of hardware, firmware, and software. The following operations may be performed by the communication module 204 (and thus by the communication node 200), and may be stored as functions on a non-transitory computer readable recording medium.

The circuitry 208 is configured to obtain situational awareness (SA) data of one or more potential communication nodes. This may be performed e.g. by execution of an obtaining function (not shown) stored in the memory 212. Obtaining the SA data may be performed by determining SA data of the communication node 200 itself using the sensor module 202. Alternatively, or in combination, the SA data may be obtained by receiving SA data of the one or more potential communication nodes from the one or more potential communication nodes by the transceiver 210. More specifically, obtaining the SA data may comprise obtaining positional information about an available friendly communication node, based on a situational awareness of the first communication node; transmitting, by the transceiver 210, to the available communication node, a first message comprising an indication of that the situational awareness data of the one or more potential communication nodes is sought; and receiving, by the transceiver 210, the situational awareness data of the one or more potential communication nodes, from the available communication node.

The circuitry 208 is further configured to determine a routing table of the one or more potential communication nodes, wherein the routing table comprises routing costs of a plurality of transmission paths between a set of communication node-pairs of the one or more potential communication nodes, and wherein the routing costs are based on the situational awareness data. This may be performed e.g. by execution of a first determining function (not shown) stored in the memory 212.

The circuitry 208 is further configured to determine a routing path from the communication node to a target node via one or more selected communication nodes of the one or more potential communication nodes, based on the routing table. This may be performed e.g. by execution of a second determining function (not shown) stored in the memory 212. Determining the routing path may be further based on a priority score of the data message. Determining the routing path may comprise selecting the routing path having the lowest total routing cost. Determining the routing path may comprise selecting the routing path as a routing path where no individual transmission path of the routing path has a routing cost exceeding a threshold.

The circuitry 208 is further configured to transmit, in accordance with the determined routing path, a data message to a second communication node of the one or more selected communication nodes, wherein the data message comprises information identifying the target node. This may be performed e.g. by execution of a first transmitting function (not shown) stored in the memory 212.

The circuitry 208 may be further configured to receive the data message from a third communication node. This may be performed e.g. by execution of a receiving function (not shown) stored in the memory 212.

The circuitry 208 may be further configured to determine one or more unsecure transmission directions and/or one or more unsecure sectors for the one or more potential communication nodes based on the obtained SA data. This may be performed e.g. by execution of a third determining function (not shown) stored in the memory 212. Determining (e.g. by the first determining function) the routing table may be further based on the one or more unsecure transmission directions and/or the one or more unsecure sectors. More specifically, the routing cost of a transmission direction may be based on whether the transmission direction coincides with an unsecure transmission direction and/or goes through an unsecure sector. The circuitry 208 may be further configured to set transmission parameters of the communication node 200 based on the SA data. In other words, transmission parameters of the transceiver 210 and/or antennas used by the transceiver 210 may be set based on the SA data.

The circuitry 208 may be further configured to, at a time interval, transmit updated situational awareness data of the first communication node itself to at least one other communication node and/or receiving updated situational awareness data associated with at least one other communication node. This may be performed e.g. by execution of a second transmitting function (not shown) stored in the memory 212.

As is readily understood by the skilled person, the functions and operations of the sensor module 202 and the communication module 204 may be distributed in the communication node 200 in any suitable way, and is not limited as how described above. For example, the communication module 204 may be implemented as an integral part of a control system of the communication node 200. In other words, the circuitry 208, the transceiver 210 and the memory 212 may be shared by other modules of the communication node 200. Moreover, the communication node 200 may comprise additional modules relating to functions and operations of the communication node 200 other than those relating to transmission of data messages. For example, the communication node 200 may be an aircraft, such as a drone or airplane. Then, the communication node 200 may comprise additional modules e.g. relating to steering and maneuvering of the aircraft.

FIG. 3A to 3C represents an illustrative example of how a data message 308 can be transmitted from a source node 302a to a target node 302f in accordance with the present inventive concept. In particular, FIGS. 3A to 3C schematically shows, in top view, three consecutive time instances of transmitting the data message 308 to the target node 302f. It goes without saying that the illustration of FIG. 3A to 3C are to be seen as a non-limiting example for improved understanding.

In the illustrated example, a source node A, indicated by reference numeral 302a, wants to transmit a data message 308 to a target node F, indicated by reference numeral 302f. By the proposed method, this can be achieved even though it for some reason might be infeasible to transmit the data message 308 directly from the source node A to the target node F. Such reason may be that the range is too far, or that no secure transmission path exist. Instead, one or more intermediate nodes 302b-e may be used to relay the data message 308. In the illustrated example, four intermediate nodes 302b-e, i.e. node B, C, D and E, are shown. However, this should merely be seen as a non-limiting example, as any number of intermediate nodes 302b-e may be present.

To securely transmit the data message 308 from the source node 302a to the target node 302f, the risk of the data message 308 being intercepted should be reduced. There could for example be a risk of an unwanted third party eavesdropping on the data transmission. Illustrated in FIG. 3A to 3C are a first and second unfriendly node 304a, 304b which are an example of this.

Each of the nodes A to F may be a communication node 200 as described above in connection with FIG. 2. Thus, each of the nodes A to F may be configured to perform the method 100 as described above in connection with FIGS. 1A and 1B. Further, even though node A is herein described as the source node 302a, and node F is described as the target node 302f, any of the nodes A to F could be the source node and/or the target node.

The nodes A to F, i.e. excluding the unfriendly nodes 304a, 304b, may together form a wireless communication network 300, such as a wireless ad-hoc network (WANET) or a mobile ad-hoc network (MANET). As a concrete example, the nodes A to F may be delivery drones as part of a package delivery system. The delivery drones may have to communicate sensitive customer data to each other, or to a base station. For this case, the present inventive concept can be utilized in order to achieve a secure transmission between delivery drones and/or the base station by reducing the risk of the transmission being intercepted. However, as is readily understood by the skilled person, the inventive concept can also be applied in other types of aircrafts, as well as for other applications, such as surface vessels. It should be noted that the communication nodes of the wireless communication network 300 may be different types of vehicles. For example, the wireless communication network 300 may comprise one or more aircraft, one or more surface vessels, and/or one or more land vehicles.

Turning now to FIG. 3A, which represents a first time instance. FIG. 3A illustrates a network topology of how node A (in this case the source node 302a) perceives its surrounding environment. The network topology herein represents the SA data (i.e. information about position and movement of the friendly and unfriendly nodes) obtained by node A, in accordance with the method 100 as described above in connection with FIGS. 1A and 1B. The SA data may either be determined by node A itself, or be fused SA data of one or more of the friendly nodes 302b to 302f representing a shared view of the surroundings.

The lines connecting two nodes herein represents different transmission paths. More specifically, a first through tenth transmission path, indicated by reference P_1 though P_10 is herein illustrated between a set of communication node pairs. The first transmission path P_1 is formed between the communication node pair A-B, the second transmission path P_2 is formed between the communication node pair A-C, and so on. The transmission paths P_1 to P_10, together with a respective routing cost can be part of the routing table determined by node A. The respective routing cost is determined based on the SA data as described above. Optionally, the routing cost can be further determined based on unsecure transmission directions and/or unsecure sectors. Herein, a first and second unsecure sector 306a, 306b is illustrated around the first and second unfriendly node 304a, 304b respectively. The unsecure sectors may for example constitute an area around an unfriendly node take into account an uncertainty in the position of the unfriendly node. However, an unsecure sector may also represent an area where there potentially could be an unfriendly node but which has not been detected for certain. An unsecure direction could for instance be the direction from node A to node C, which passes through the first unfriendly node 304a.

For illustrative purposes, the routing cost (in terms of security) of the first through tenth transmission paths P_1 to P_10 has three different levels (e.g. low, medium and high cost) which are represented by three different dash types. The solid lines represents the lowest routing cost, i.e. the most preferred transmission path. The lowest routing cost is herein assigned to transmission paths which has no or low risk of being intercepted by an unfriendly node. The small dashed lines (e.g. the line representing the third transmission path P_3) represents a medium routing cost. The medium routing cost is herein assigned to transmission paths which are close to an unfriendly node, or intersects with an unsecure sector. The large dashed lines (e.g. the line representing the second transmission path P_2) represents the highest routing cost, i.e. the least preferred transmission path. The highest routing cost is assigned to transmission paths which intersects with an unfriendly node, or coincides with an unsecure transmission direction. It should be noted that the routing cost may be implemented in other ways. For example, the routing cost could take either discrete or continuous values of any scale. The example illustrated herein should merely be seen as a non-limiting example.

Upon the routing table being determined, node A determines a routing path from itself to the target node 302f, i.e. node F, based on the routing table, and thus also the current situational awareness. The routing path may for example be determined as A-B-E-F, i.e. through the first, fourth and ninth transmission paths P_1, P_4, P_9, as this may constitute the routing path having the lowest routing cost and requiring the fewest intermediate nodes. As another example, if a priority score of the data message is taken into account (as described above in connection with FIGS. 1A and 1B) the routing path may be determined e.g. as A-D-F, i.e. through the third and tenth transmission paths P_3 and P_10. In this case, the third transmission path P_3 is selected, despite it having a medium routing cost because the priority score may indicate that it is more important that the data message 308 reaches the target node 302f quickly, then that it is delivered in the most secure way.

For the continued explanation of the present example, the routing path of A-B-E-F is assumed to have been determined. Thus, node A transmits the data message 308 to node B along the first transmission path P_1, together with information identifying the target node 302f. As stated above, transmission parameters may be set based on the SA data. For example, a signal power of the transmission may be set based on the distance of a transmission path. As another example, pattern shaping of the transmission may be set based on how close a transmission path is to an unfriendly node. For instance, in case the third transmission path P_3 would have been selected, the data message may have been transmitted using a radiation pattern with a narrow main lobe, to lower the risk of the first unfriendly node 304a intercepts the data message 308.

Next, turning to FIG. 3B, the network topology in a second time instance, after node B has received the data message 308 from node A, is shown. Since the nodes may be mobile nodes, their position and movement may change between time instances. Herein, nodes A to F, as well as the first and second unfriendly nodes 304a, 304b has all moved since the previous time instance. Therefore, the network topology of FIG. 3B is slightly different from FIG. 3A.

Node B is now the node which will perform the method 100 (cf. first communication node) as described above. Node B obtains new SA data which describes the current situation which gives node B an updated view of the situation. Then, a new routing table is determined, based on the new SA data. As seen in the present example, the second unfriendly node 304b has moved such that it may intercept the ninth transmission path P_9, which was previously part of the routing path determined by node A. The new situation in FIG. 3B makes this transmission path unsuitable for secure transmission. The ninth transmission path P_9 has therefore been assigned a high routing cost. Based on the new routing table, node B can determine a new routing path. For the purpose of this non-limiting example, the determined routing path is assumed to be B-C-F, i.e. through the sixth and seventh transmission path P_6, P_7, as it provides low routing cost. Lastly, node B transmits the data message 308 to node C, along the sixth transmission path P_6, together with information identifying the target node 302f.

Lastly, turning to FIG. 3C, the network topology in a third time instance, after node C has received the data message 308 from node B, is shown. Again, the situation has changed since the previous node (herein node B) transmitted the data message 308 to the current node (node C). Therefore, node C obtains new SA data describing the current situation, determines a new routing table and determines a new routing path. In this case however, the routing path remains the same as determined by the previous node (node B). Thus, the data message 308 is transmitted to node F, through the seventh transmission path P_7, finally reaching the target node 302f.

It should be noted that the set of communication node-pairs between which transmission paths are present need not to be the same each time a node determines a routing table. For example, as illustrated in FIG. 3C, transmission paths which are no longer feasible may be removed (i.e. the tenth transmission path P_10 between node D and node F, as seen in FIG. 3B). As another example, new transmission paths may be added (i.e. the eleventh transmission path P_11 between node C and node E). Further, nodes may be added or removed from the wireless communication network 300, as they come in or out of range. Moreover, new unfriendly nodes may appear, or previous unfriendly nodes may disappear as time goes.

Additionally, variations to the disclosed variants can be understood and effected by the skilled person in practicing the claimed invention, from a study of the drawings, the disclosure, and the appended claims.

1. A computer implemented method (100), performed in a first communication node, for secure transmission of a data message from a source node (302a) to a target node (302f) through one or more intermediate nodes (302b-e), the method (100) comprising:
obtaining (S104) situational awareness (SA) data of one or more potential communication nodes, wherein the situational awareness data comprises information about a position and movement of said one or more potential communication nodes, and a classification defining each of said one or more potential communication nodes as either friendly or unfriendly;
determining (S114) a routing table of the one or more potential communication nodes, wherein the routing table comprises routing costs of a plurality of transmission paths (P_1-P_10) between a set of communication node-pairs of the one or more potential communication nodes, and wherein the routing costs are based on the situational awareness data;
determining (S116) a routing path from the first communication node to the target node (302f) via one or more selected communication nodes of the one or more potential communication nodes, based on the routing table; and
transmitting (S124), in accordance with the determined routing path, the data message to a second communication node of the one or more selected communication nodes, wherein the data message comprises information identifying the target node.

2. The method (100) according to claim 1, wherein the first communication node is the source node (302a).

3. The method (100) according to claim 1, wherein the second communication node is the target node (302f).

4. The method (100) according to claim 1, wherein the method (100) further comprises receiving (S102) the data message from a third communication node.

5. The method (100) according to claim 1,
wherein the method (100) further comprises determining (S112) one or more unsecure transmission directions and/or one or more unsecure sectors for the one or more potential communication nodes based on the obtained SA data; and
wherein determining (S114) the routing table is further based on the one or more unsecure transmission directions and/or the one or more unsecure sectors.

6. The method (100) according to claim 1, wherein the data message is associated with a priority score, and wherein determining (S116) the routing path is further based on the priority score of the data message.

7. The method (100) according to claim 1, wherein determining (S116) the routing path further comprises selecting (S118) the routing path having the lowest total routing cost.

8. The method (100) according to claim 1, wherein determining (S116) the routing path further comprises selecting (S120) the routing path as a routing path where no individual transmission path of the routing path has a routing cost exceeding a threshold.

9. The method (100) according to claim 1, wherein obtaining (S104) the situational awareness data comprises:
obtaining (S106) positional information about an available friendly communication node, based on a situational awareness of the first communication node;
transmitting (S108), to the available communication node, a first message comprising an indication of that the situational awareness data of the one or more potential communication nodes is sought; and
receiving (S110) the situational awareness data of the one or more potential communication nodes, from the available communication node.

10. The method (100) according to claim 1, wherein transmitting (S124) the data message to the second communication node is performed by directional antennas.

11. The method (100) according to claim 1, wherein the method further comprises setting (S122) transmission parameters of the first communication node based on the situational awareness data.

12. The method (100) according to claim 1, wherein the situational awareness data is maintained by a wireless communication network (300) formed by a plurality of friendly communication nodes (302a-f).

13. The method (100) according to claim 12, further comprising, at a time interval, transmitting (S126) updated situational awareness data of the first communication node itself to at least one other communication node of the wireless communication network and/or receiving updated situational awareness data associated with at least one other communication node of the wireless communication network.

14. The method (100) according to claim 12, wherein the wireless communication network is a mobile ad-hoc network, MANET.

15. The method (100) according to claim 12, wherein the wireless communication network is any one of an air-to-air, air-to-surface, or surface-to-surface communication network.

16. The method (100) according to claim 1, wherein the communication nodes are aircraft.

17. A non-transitory computer-readable storage medium storing one or more programs configured to be executed by one or more processors of a processing system, the one or more programs comprising instructions for performing the method (100) according to claim 1.

18. A communication node (200) configured to transmit and receive data messages in a network of communication nodes, the communication node (200) comprising:
a sensor module (202) configured to determine situational awareness data of the communication node (200), wherein the situational awareness data comprises information about a position and movement of neighboring communication nodes and a classification defining each neighboring node as either friendly or unfriendly; and
a communication module (204) configured to transmit and receive data messages from and to the communication node (200),
wherein the communication module (204) comprises circuitry (208) configured to:
obtain situational awareness data of one or more potential communication nodes,
determine a routing table of the one or more potential communication nodes, wherein the routing table comprises routing costs of a plurality of transmission paths between a set of communication node-pairs of the one or more potential communication nodes, and wherein the routing costs are based on the situational awareness data,
determine a routing path from the communication node to a target node via one or more selected communication nodes of the one or more potential communication nodes, based on the routing table, and
transmit, in accordance with the determined routing path, a data message to a second communication node of the one or more selected communication nodes, wherein the data message comprises information identifying the target node.
